(19) United States
(12) Patent Application Publication
(10) Pub. No.: US 2013/0194311 A1
(43) Pub. Date: Aug. 1, 2013

(54) IMAGE REPRODUCING APPARATUS

(71) Applicant: Sanyo Electric Co., Ltd., Moriguchi-shi (JP)

(72) Inventor: Kazuhisa Tashima, Osaka-shi (JP)

(73) Assignee: SANYO ELECTRIC CO., LTD., Moriguchi-shi (JP)

(21) Appl. No.: 13/754,269

(22) Filed: Jan. 30, 2013

(30) Foreign Application Priority Data
Jan. 31, 2012 (JP) 2012-17741

(51) Int. Cl. G09G 5/38

(52) U.S. Cl. CPC G09G 5/38
USPC 345/660

(57) ABSTRACT

An image reproducing apparatus includes a first displayer. A first displayer displays a photographed image having a size equivalent to a size of a monitor screen, on the monitor screen. A first changer changes a position of the photographed image displayed by the first displayer when a position changing operation is sensed so as to ensure a vacant region in a peripheral portion of the monitor screen. A second displayer displays attribute information indicating an attribute of the photographed image displayed by the first displayer, in the vacant region ensured by the first changer.

### CROSS REFERENCE OF RELATED APPLICATION

The disclosure of Japanese Patent Application No. 2012-17741, which was filed on Jan. 31, 2012, is incorporated herein by reference.

### BACKGROUND OF THE INVENTION

1. Field of the Invention

The present invention relates to an image reproducing apparatus, and more particularly, relates to an image reproducing apparatus which executes a process different depending on a touch operation manner.

2. Description of the Related Art

According to one example of this type of apparatus, an operation detecting portion detects an operation instruction on an image displayed on a display portion. A display-image creating portion includes a live view image outputted from an imaging portion and an information image indicating information on an operation, and creates a display-use image of a predetermined range to be displayed on a display portion, of from an entire image configured so that different types of information images are combined together at a position equivalent to a different side of a square shape of the live view image. A display-image controlling portion controls the display-image creating portion so that the display-use image is created from the entire image, in a manner according to an operation command detected by the operation detecting portion.

In the above-described apparatus, it is disclosed that the live view image outputted from the imaging portion and one portion of the entire image configured by the information image are displayed; however, an operation at the time of reproducing a photographed image is not disclosed. Furthermore, when the above-described apparatus is used at the time of reproducing the photographed image, in order to display the information on the photographed image, it is necessary to newly increase the number of items to be displayed, in addition to the information image representing the information on the operation, and as a result, it is probable that a screen display is complicated. This may deteriorate an operability for the reproduction of the photographed image.

### SUMMARY OF THE INVENTION

An image reproducing apparatus according to the present invention, comprises: a first displayer which displays a photographed image having a size equivalent to a size of a monitor screen, on the monitor screen; a first changer which changes a position of the photographed image displayed by the first displayer when a position changing operation is sensed so as to ensure a vacant region in a peripheral portion of the monitor screen; a second displayer which displays attribute information indicating an attribute of the photographed image displayed by the first displayer, in the vacant region ensured by the first changer;

An image reproducing apparatus according to the present invention, comprises: a fourth displayer which displays the photographed image on the monitor screen; a reducer which reduces the size of the photographed image displayed by the fourth displayer, in response to a pinch-in operation on the monitor screen; a fifth displayer which displays one or at least two icons in the vacant region formed in the peripheral portion of the monitor screen by the process of the reducer; a receiver which receives a selection operation for selecting any one of the one or at least two icons displayed by the fifth displayer; and a processor which executes a process corresponding to an icon selected by a selection operation, on the photographed image displayed by the fourth displayer.

According to the present invention, an image reproducing program which is recorded on a non-temporary recording medium in order to control an image reproducing apparatus, wherein the program causes a processor of the image reproducing apparatus to execute: a first display step of displaying a photographed image having a size equivalent to a size of a monitor screen, on the monitor screen; a first change step of changing a position of the photographed image displayed by the first display step, when a position change operation is sensed, so as to ensure a vacant region in a peripheral portion of the monitor screen; and a second display step of displaying attribute information indicating an attribute of the photographed image displayed by the first display step, in the vacant region ensured by the first change step.

According to the present invention, an image reproducing method executed by an image reproducing apparatus, comprises: a first display step of displaying a photographed image having a size equivalent to a size of a monitor screen, on the monitor screen; a first change step of changing a position of the photographed image displayed by the first display step, when a position change operation is sensed, so as to ensure a vacant region in a peripheral portion of the monitor screen; and a second display step of displaying attribute information indicating an attribute of the photographed image displayed by the first display step, in the vacant region ensured by the first change step.

The above described characteristics and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of a frame image used in the embodiment in FIG. 2;

FIG. 4 is an illustrative view showing one example of a reproduction-use image created in the embodiment in FIG. 2;

FIG. 5(A) is an illustrative view showing one example of a display on an LCD monitor;

FIG. 5(B) is an illustrative view showing one example of a slide operation;

FIG. 6(A) is an illustrative view showing another example of the slide operation;

FIG. 6(B) is an illustrative view showing another example of the display on the LCD monitor;

FIG. 7(A) is an illustrative view showing still another example of the display on the LCD monitor;

FIG. 7(B) is an illustrative view showing still another example of the slide operation;

FIG. 8(A) is an illustrative view showing one example of a pinch-in operation;

FIG. 8(B) is an illustrative view showing one example of a slide operation after the pinch-in operation;

FIG. 9 is a flowchart showing one portion of an operation in a CPU applied to the embodiment in FIG. 2;

FIG. 10 is a flowchart showing another portion of the operation in the CPU applied to the embodiment in FIG. 2;

FIG. 11 is a flowchart showing still another portion of the operation in the CPU applied to the embodiment in FIG. 2;

FIG. 12(A) is an illustrative view showing yet another example of the display on the LCD monitor;

FIG. 12(B) is an illustrative view showing another example of the display on the LCD monitor; and

FIG. 13 is a block diagram showing a configuration of another embodiment of the present invention.

### DETAILED DESCRIPTION OF THE PREFERRED EMBODIMENTS

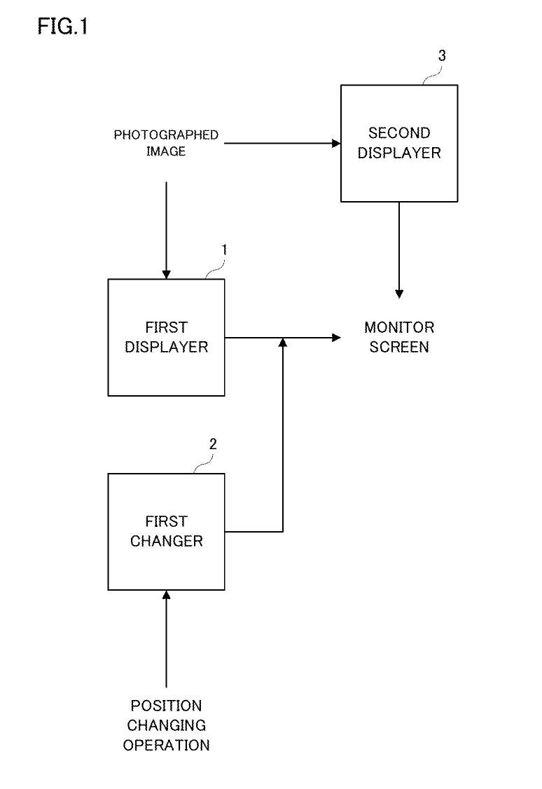

With reference to FIG. 1, an image reproducing apparatus in one embodiment of the present invention is basically configured as follows: A first displayer 1 displays a photographed image having a size equivalent to a size of a monitor screen, on the monitor screen. A first changer 2 changes a position of the photographed image displayed by the first displayer 1 when a position changing operation is sensed so as to ensure a vacant region in a peripheral portion of the monitor screen. A second displayer 3 displays attribute information indicating an attribute of the photographed image displayed by the first displayer 1, in the vacant region ensured by the first changer 2.

When the position of the photographed image displayed on the monitor screen is changed in response to the position changing operation, the vacant region is ensured in the peripheral portion of the monitor screen. The attribute information indicating the attribute of the photographed image is displayed in the vacant region thus ensured. Thereby, it is possible to easily confirm the attribute of the photographed image while maintaining a visibility of the photographed image. In this way, the operability for the reproduction of the photographed image is improved.

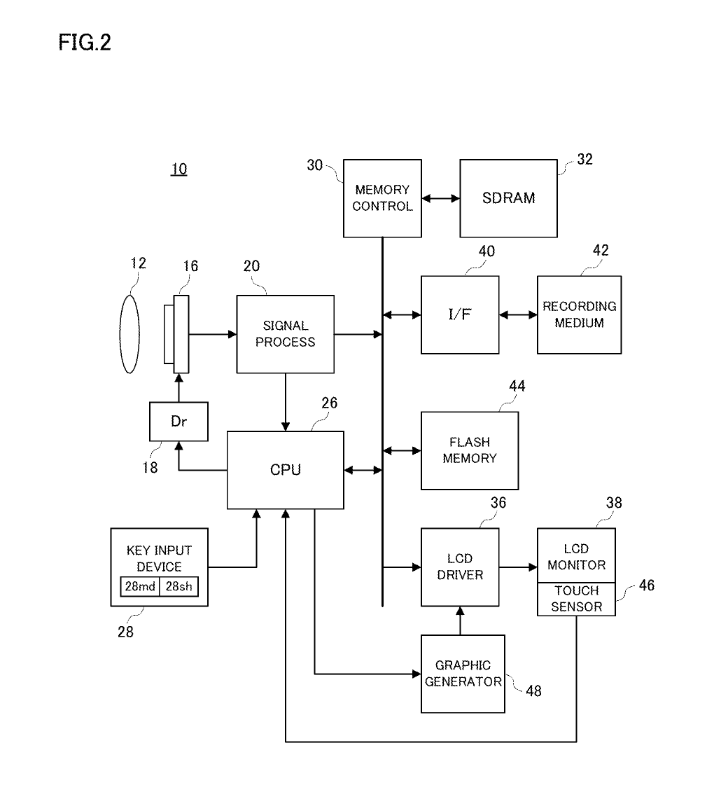

With reference to FIG. 2, a digital camera 10 of this embodiment includes a focus lens 12 driven by a driver 18, and an image sensor 16. An optical image of a scene that undergoes theses members enters, with irradiation, an imaging surface of the image sensor 16, and is subject to a photoelectric conversion. Thereby, electric-charges representing a scene are generated. If an entire system is activated, a CPU 26 determines a state (that is, an operation mode at this time point) of a mode change button 28md provided in a key input device 28 under a main task, activates an imaging task corresponding to an imaging mode, and activates a reproducing task corresponding to a reproducing mode.

If the imaging task is activated, in order to execute a moving image taking process, the CPU 26 instructs the driver 18 to repeat an exposure operation and an electric-charge reading-out operation. In response to a vertical synchronization signal Vsync periodically generated from a signal generator (SG) not shown, the driver 18 exposes the imaging surface and reads out the electric charges produced on the imaging surface in a raster scanning manner. From the image sensor 16, raw image data based on the read-out electric charges is periodically outputted.

A signal processing circuit 20 performs processes such as a white balance adjustment, a color separation, or a YUV conversion onto the raw image data outputted from the image sensor 16, and writes YUV-formatted image data generated thereby into an SDRAM 32 through a memory control circuit 30. An LCD driver 36 repeatedly reads out the image data accommodated in the SDRAM 32 through the memory control circuit 30, and drives an LCD monitor 38 based on the read-out image data. As a result, a moving image representing a scene is displayed on a monitor screen.

When a shutter button 28sh is fully depressed under the imaging task, a still image taking process and a recording process are executed. One frame of image data obtained when the shutter button 28sh is fully depressed is taken in the SDRAM 32 through the still image taking process. One frame of the taken image data is read out by an I/F 40 that is activated in association with the recording process, and is recorded on a recording medium 42 in a file format.

When a reproducing task is activated, the CPU 26 designates one image file recorded on the recording medium 42, and executes a reproduction-use image creating process in which the designated image file is focused.

In the reproduction-use image creating process, the CPU 26 reads out from the recording medium 42 the image data of each of the designated image file, an image file recorded thereon immediately before the designated image file, and an image file recorded thereon immediately after the designated image file. The CPU 26 reads out photographing data added to each of these image files. Examples of the photographing data that is subject to read out include: a date (year, month, and day) of photograph; an image size; a photograph mode at the time of photographing; presence or absence of a flash firing; the number of pixels; an ISO sensitivity; a white balance; and a correction value of an exposure. By using the image data and the photographing data thus read out, the CPU 26 commands a graphic generator 48 to create a reproduction-use image GP.

The graphic generator 48 creates display-use image data by resizing each of the read-out image data. The graphic generator 48 also converts the read-out photographing data into an image. Herein, when converting a selection item such as the imaging mode and the presence or absence of a flash firing into an image, an image that matches the photographing data is selected from among a plurality of images previously prepared. Furthermore, when converting a numeric value such as the date of photograph, the image size, and the number of pixels into an image, a plurality of images previously prepared, representing a character, are pieced together.

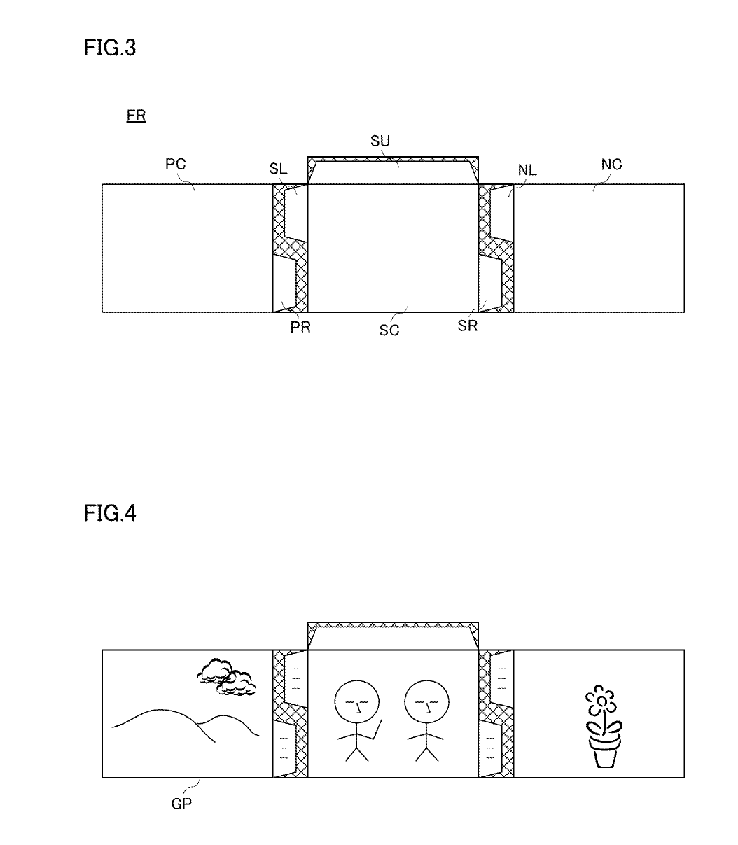

Moreover, a frame image FR is prepared in order to create the reproduction-use image GP. The frame image FR includes photographed-image areas SC, PC, and NC, and tag areas SU, SL, SR, PR and NL, as shown in FIG. 3.

The graphic generator 48 combines each of the display-use images of the designated image file, the image file recorded thereon immediately before the designated image file, and the image file recorded thereon immediately after the designated image file, in the photographed-image areas SC, PC, and NC, respectively.

The graphic generator 48 also combines each of the photographing data that are converted into an image, into the tag areas SU, SL, SR, PR, and NL respectively. Into the tag areas SU, SL, and SR, image-converted photographing data of the designated image file is combined. Into the tag area PR, image-converted photographing data of the image file recorded immediately before the designated image file is combined. Into the tag area NL, image-converted photographing data of the image file recorded immediately after the designated image file is combined.

The image-converted photographing data combined into the tag area SU are the date of photograph; a time of photograph; a file name; and the image size, out of the photographing data. The image-converted photographing data combined into the tag areas SL and NL are the photographing mode and the presence or absence of a flash firing, out of the photographing data. The image-converted photographing data combined into the tag areas SR and PR are the number of pixels, the ISO sensitivity, the white balance, and the correction value of the exposure, out of the photographing data.

Moreover, a total number of images to be photographed, and a number at which the designated image file is positioned out of the total number of images, are read out from the recording medium 42. The character representing the information thus read-out is converted into an image, which is combined into the tag area SU. Likewise, when the designated image file or the image file recorded immediately after the designated image file has been uploaded to another device, an upload target is read out from the recording medium 42. In this case, an image indicating the upload target is selected from among the plurality of previously prepared images, and combined into the tag area SL or NL.

Such a reproduction-use image creating process is executed at each time the image file is newly designated, and the reproduction-use image GP is created as shown in FIG. 4.

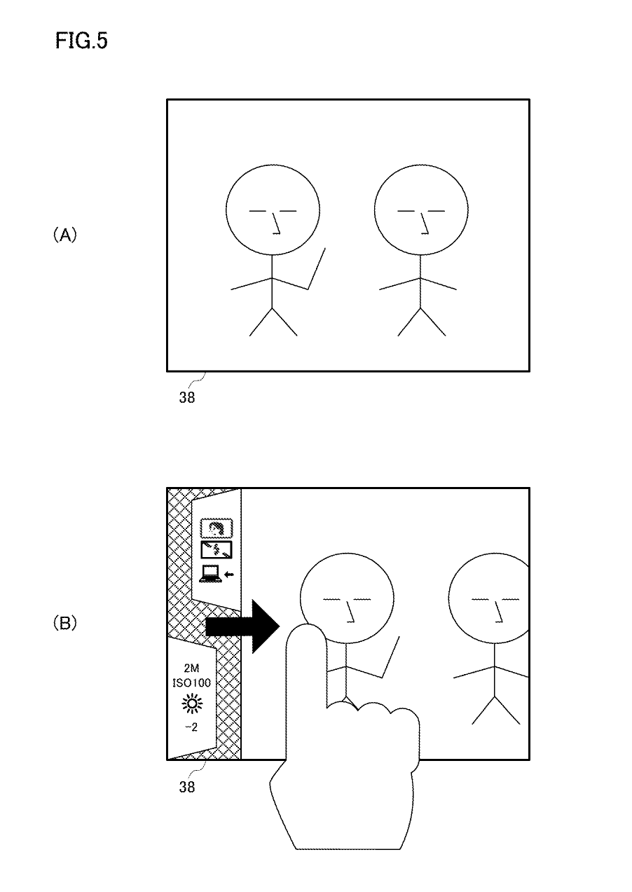

Upon completion of the reproduction-use image creating process, the CPU 26 commands the graphic generator 48 and the LCD driver 36 to execute a reproducing process in which the designated image file is focused. The graphic generator 48 outputs the image data of the reproduction-use image GP toward the LCD driver 36. The LCD driver 36 displays a range corresponding to the designated image file, out of the reproduction-use image GP, on the LCD monitor 38, as shown in FIG. 5(A).

When a touch operation on the LCD monitor 38 is performed by an operator during the execution of the reproducing task, a touched position is sensed by a touch sensor 46 and a sense result is applied to the CPU 26.

When the touched position is changed with a finger of the operator touching the LCD monitor 38, that is, when a slide operation is performed, this operation is sensed by the touch sensor 46, and a sense result is applied to the CPU 26. The CPU 26 commands the LCD driver 36, based on a detection result, to scroll the reproduction-use image GP. As a result, a display of the reproduction-use image GP on the LCD monitor 38 is scrolled in accordance with a slide direction and a slide amount.

According to an example shown in FIG. 5(A), when the operator performs a slide operation in the right direction of the screen, the display of the reproduction-use image GP is scrolled in the right direction. As a result, as shown in FIG. 5(B), imaging data of the designated image file combined into the tag area SL of the frame image FR and photographing data of the image file recorded immediately before the designated image file combined into the tag area PR are displayed on the LCD monitor 38. On the other hand, one portion on the right side of the designated image is non-displayed.

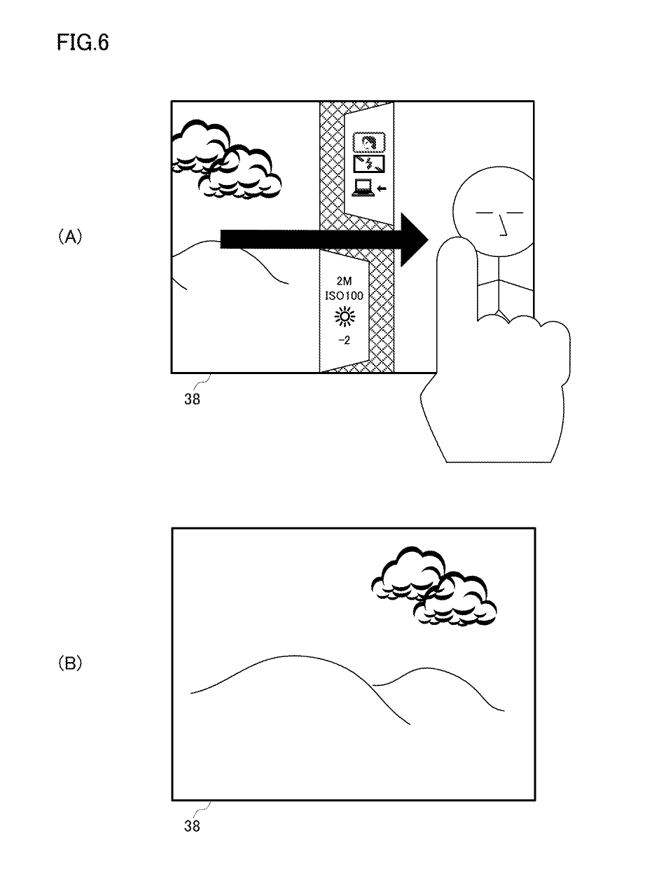

When a slide operation is performed to drag the state of FIG. 5(B) further in the right direction, one portion of the image recorded immediately before the designated image file is displayed, as shown in FIG. 6(A).

When the touched position is not sensed by the touch sensor 46, that is, when the finger of the operator leaves the LCD monitor 38 and the touch operation is ended, if the slide amount is equal to or less than a predetermined amount, then the display of the reproduction-use image GP is scrolled so as to return to the original state. As a result, the display on the LCD monitor 38 is returned to a display in which the whole of the designated image is shown. On the other hand, when the slide amount exceeds the predetermined amount, the display of the reproduction-use image GP is scrolled to the end of the slide direction. Subsequently, an image file in accordance with the slide direction is newly designated, and in this state, the reproduction-use image creating process is executed.

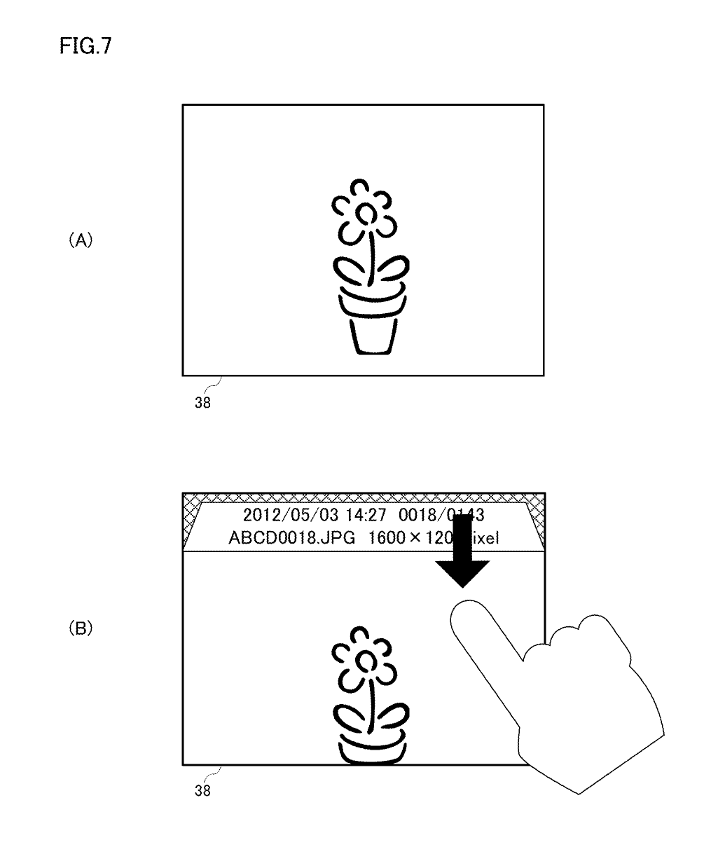

The predetermined amount has, for example, a length half a screen width. In this case, when the touch operation is ended in the state of FIG. 5(B), the display on the LCD monitor 38 is returned to the state of FIG. 5(A). On the other hand, when the touch operation is ended in the state of FIG. 6(A), the display on the LCD monitor 38 proceeds to a state of FIG. 6(B). According to an example shown in FIG. 7(A), when the operator performs a slide operation to move in the downward direction of the screen, the display of the reproduction-use image GP is scrolled in the downward direction. As a result, as shown in FIG. 7(B), photographing data of the designated image file combined into the tag area SU of the frame image FR is displayed on the LCD monitor 38. On the other hand, one portion of a lower side of the designated image is non-displayed. Furthermore, when the touch operation is ended in the state of FIG. 7(B), the display on the LCD monitor 38 is returned to the state of FIG. 7(A).

When a distance between two points on the LCD monitor 38 touched by two fingers of the operator is reduced while maintaining a state where these two fingers touches the LCD monitor 38, that is, when a pinch-in operation is performed, this operation is sensed by the touch sensor 46, and a sense result is applied to the CPU 26. The CPU 26 that receives the sense result executes the following processes.

The CPU 26 commands the graphic generator 48 to perform a mask process on the reproduction-use image GP. Portions other than the designated image, out of the reproduction-use image GP, that is, portions equivalent to the photograph image areas PC and NC including the combined display-use image and the tag areas SU, SL, SR, PR, and NL including the combined image-converted photographing data, are subject to black-out by the mask process. Furthermore, the reproduction-use image GP on which the mask process has been performed is reduced and displayed. Subsequently, the CPU 26 multiple-displays four icons on the reproduction-use image GP so that the designated image is surrounded. Such four icons correspond to respectively different processes.

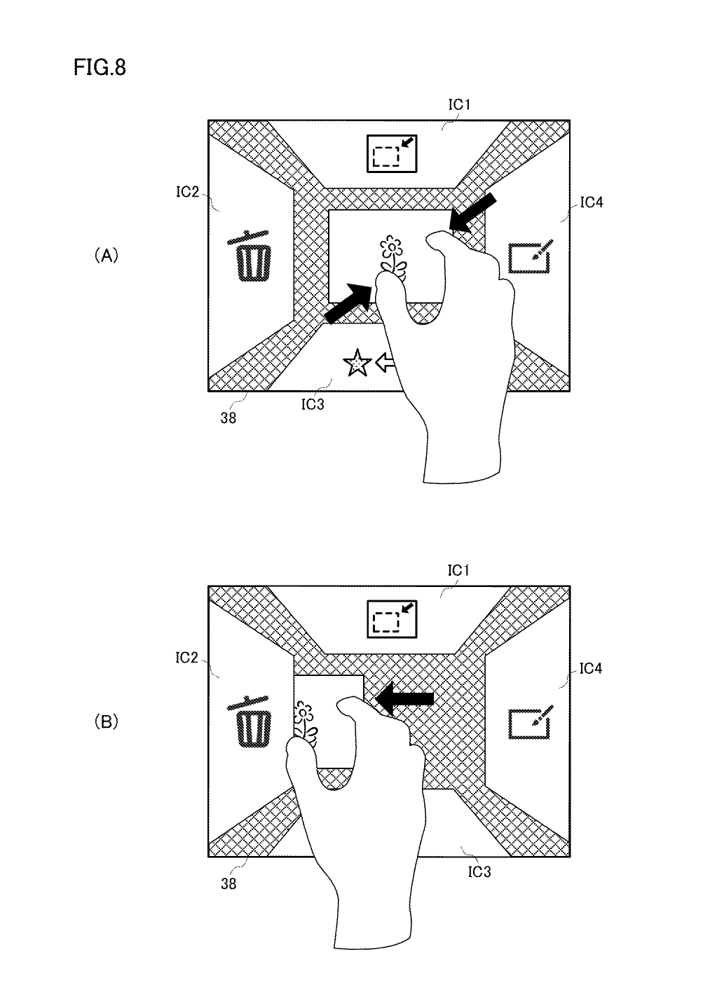

According to an example shown in FIG. 7(A), when the operator performs the pinch-in operation, the reproduction-use image GP undergoes the mask process and then is reduced and displayed, and the icons are multiple-displayed. As a result, as shown in FIG. 8(A), icons IC1 to IC4 are displayed on the LCD monitor 38 so that the designated image is surrounded. The icons IC1 to IC4 correspond to “resize of an image”, “deletion of an image file”, “bookmark of an image file”, and “re-touch of an image”, respectively.

When the touch position is changed in a state where the two fingers of the operator who has performed the pinch-in operation touch the LCD monitor 38, that is, when the slide operation is performed, this operation is sensed by the touch sensor 46, and a sense result is applied to the CPU 26. The CPU 26 commands the LCD driver 36, based on a detection result, to scroll the reproduction-use image GP. As a result, the display of the reduced reproduction-use image GP is scrolled according to the slide direction and the slide amount.

According to an example shown in FIG. 8(A), when the slide operation is performed in the left direction of the screen after the operator performs the pinch-in operation, the display of the reduced reproduction-use image GP is scrolled in the left direction. It should be noted that the display of the icons IC1 to IC4 is not scrolled. As a result, as shown in FIG. 8(B), the display on the LCD monitor 38 is changed so that the designated image overlaps beneath the icon IC2 displayed on the left side of the screen.

When the touch operation is ended in a state where the overlapping of the designated image and the icon is equal to or less than the predetermined amount, the display of the reproduction-use image GP is scrolled so as to return to the original state. Thereby, the display on the LCD monitor 38 is returned to a display where the designated image is mainly featured. Moreover, the mask process is cancelled and non-display of the icon is executed, and the reduced display of the reproduction-use image GP is ended. Thereby, the display on the LCD monitor 38 is returned to a state before the pinch-in operation. On the other hand, when the overlapping exceeds the predetermined amount by the slide operation, the CPU 26 executes a process corresponding to an icon that overlaps the designated image. The predetermined amount is an area half the reduced designated image, for example.

According to an example shown in FIG. 8(B), when the overlapping of the icon IC2 and the designated image exceeds half the area of the designated image as a result of the operator further continuing the slide operation in the left direction of the screen, a process of “deletion of an image file” corresponding to the icon IC2 is executed. Accordingly, the designated image file is deleted.

Furthermore, in order to notify that this process is executed if the overlapping progresses any further, it may be possible to change a mode in which the overlapping icon is displayed, immediately before the process corresponding to the icon is executed by the slide operation. For example, the overlapping of any one of the icons IC1 to IC4 and the designated image is from equal to or less than half the area of the designated image to within a predetermined range, the display mode change is executed. When the display mode is changed, a luminance of an icon may increase, or an icon may blink, for example.

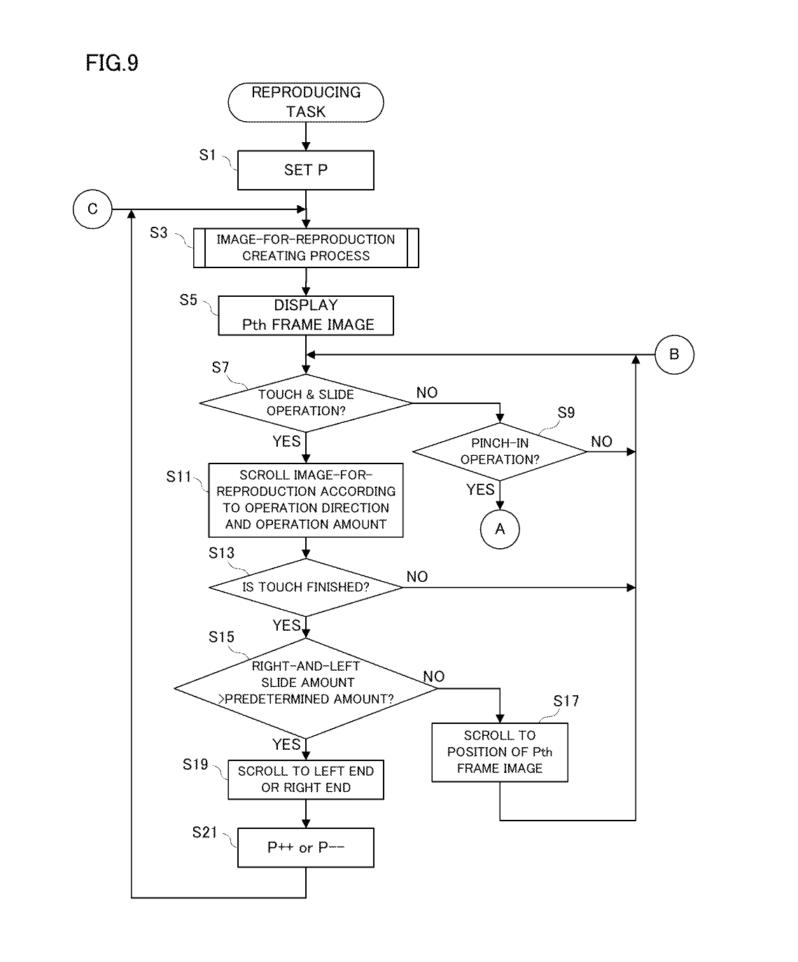

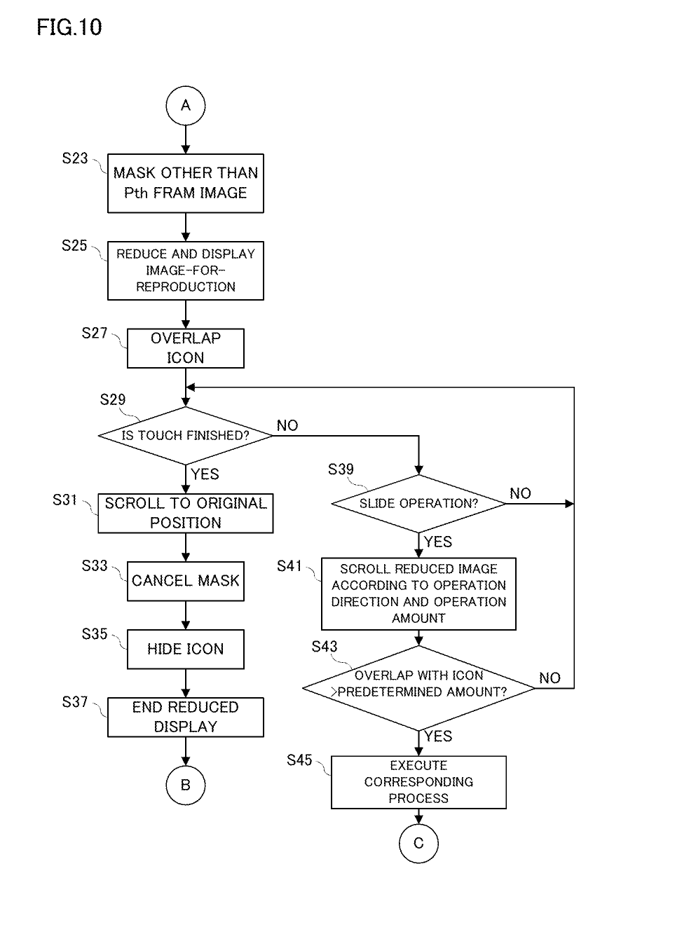

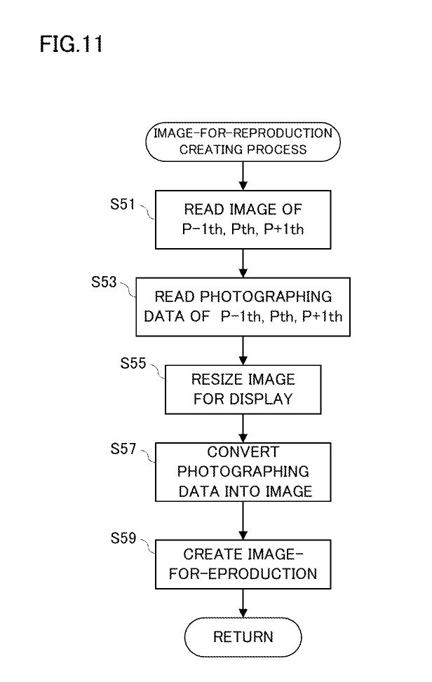

The CPU 26 executes, in a parallel manner, a plurality of processes including a reproducing task shown in FIG. 9 and FIG. 10. It is noted that a control program corresponding to these processes is stored in a flash memory 44.

With reference to FIG. 9, in a step S1, the number based on an operation or a predetermined number is set to a variable P. In a step S3, a reproduction-use image creating process focused on an image file of a P-th frame recorded on the recording medium 42 is executed.

In a step S5, the graphic generator 48 and the LCD driver 36 are commanded to execute a reproducing process where the image file of a P-th frame is focused. As a result, a range corresponding to the designated image file, out of the reproduction-use image GP, is displayed on the LCD monitor 38.

In a step S7, it is determined whether or not the touch operation and the slide operation are performed on the LCD monitor 38, and when a determination result is YES, the process proceeds to a step S11 while if the determination result is NO, the process proceeds to a step S9.

In the step S9, it is determined whether or not the pinch-in operation is performed on the LCD monitor 38, and when a determination result is YES, the process proceeds to a step S23 while if the determination result is NO, the process returns to the step S7.

In the step S11, the display of the reproduction-use image GP on the LCD monitor 38 is scrolled according to an operation direction and an operation amount. In a step S13, it is determined whether or not the touch operation is finished. When a determination result is NO, the process returns to the step S7 while when the determination result is YES, the process proceeds to a step S15.

In the step S15, it is determined whether or not the slide amount in the left direction or the right direction of the screen exceeds the predetermined amount, when a determination result is NO, the process proceeds to a step S17 while when the determination result is YES, the process proceeds to a step S19.

In the step S17, the display of the reproduction-use image GP is scrolled so as to return to the display where the whole of the image of a P-th frame is displayed. Upon completion of the process in the step S17, the process returns to the step S7.

In the step S19, the display of the reproduction-use image GP is scrolled to the end of the slide direction. In a step S21, the variable P is incremented or decremented according to the slide direction and thereafter, the process returns to the step S3.

In the step S23, the mask process is executed on a portion other than the designated image, out of the reproduction-use image GP. In a step S25, the reproduction-use image GP on which the mask process has been performed is reduced and displayed. In a step S27, the icons are multiple-displayed on the reproduction-use image GP so that the designated image is surrounded.

In a step S29, it is determined whether or not the touch operation is ended, and when a determination result is NO, the process proceeds to a step S39 while when the determination result is YES, the process proceeds to a step S31.

In the step S31, the scroll is performed so that the display of the reproduction-use image GP is returned to the original state. As a result, the display on the LCD monitor 38 is returned to the reduced display of the P-th image. In a step S33, the mask process of the reproduction-use image GP is cancelled, and in a step S35, the icon is non-displayed. In a step S37, the reduced display of the reproduction-use image GP is ended, and thereafter, the process returns to the step S7.

In the step S39, it is determined whether or not the slide operation is performed on the LCD monitor 38, and when a determination result is YES, the process proceeds to a step S41 while when the determination result is NO, the process returns to the step S29. In the step S41, the display of the reproduction-use image GP reduced on the LCD monitor 38 is scrolled according to the operation direction and the operation amount.

In a step S43, it is determined whether or not the overlapping of the reduced P-th image and the icon exceeds the predetermined amount, and when a determination result is NO, the process returns to the step S29. On the other hand, when the determination result is YES, the process corresponding to the overlapping icon is executed on the image file of a P-th frame in a step S45. Upon completion of the process in the step S45, the process returns to the step S3.

The reproduction-use image creating process in the step S3 in FIG. 9 is executed according to a subroutine shown in FIG. 11. In a step S51, image data of each of an image file of a (P−1)th frame, an image file of a P-th frame, and an image file of a (P+1)th frame is read out from the recording medium 42. In a step S53, the photographing data added to each of the image files read out in the step S51 is read out.

In a step S55, each of the image data read out in the step S51 is resized, and the display-use image data is created. In a step S57, each of the read-out photographing data is converted into an image.

In a step S59, the display-use image data created in the step S55, the image-converted photographing data created in the step S57, and the previously prepared frame image FR are used to create the reproduction-use image GP. Upon completion of the process in the step S59, the process is returned to the routine at a hierarchical upper level.

As understood from the above description, the CPU 26 displays on the LCD monitor 38 the photographed image having a size equivalent to a size of the LCD monitor 38, changes the position of the photographed image displayed when the position changing operation is sensed, and ensures a vacant region in a peripheral portion of the LCD monitor 38. Moreover, the CPU 26 displays attribute information indicating an attribute of the photographed image displayed, in the ensured vacant region.

When the position of the photographed image displayed on the LCD monitor 38 is changed in response to the position changing operation, the vacant region is ensured in the peripheral portion of the LCD monitor 38. The attribute information indicating the attribute of the photographed image is displayed in the vacant region thus ensured. Thereby, it is possible to easily confirm the attribute of the photographed image while maintaining a visibility of the photographed image. In this way, the operability for the reproduction of the photographed image is improved.

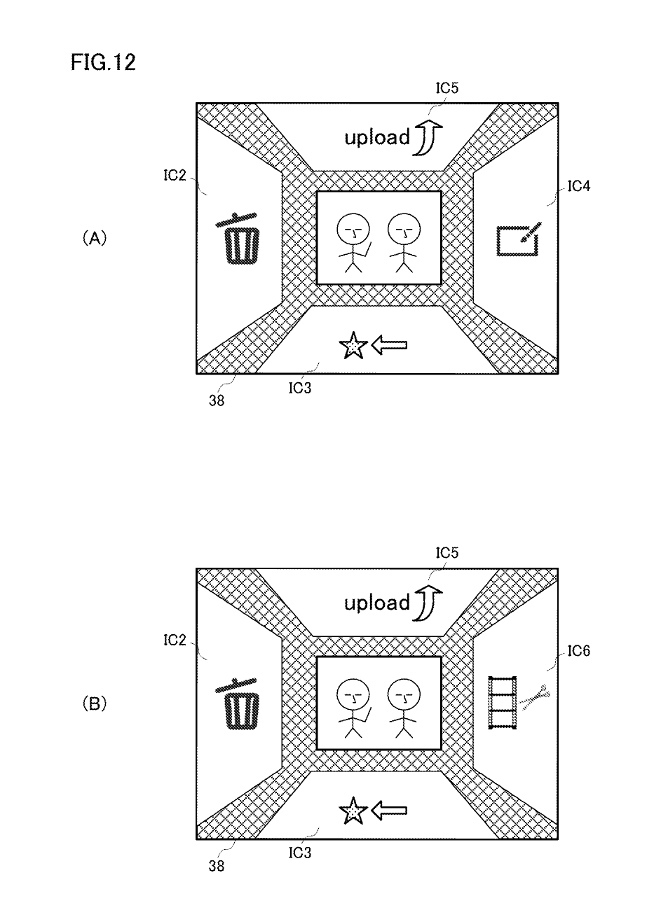

It is noted that in this embodiment, one example of the icon displayed when the pinch-in operation is performed is shown, however, the displayed icon may be changed depending on the size or the type of the image file. For example, when the size of the image file is equal to or less than a predetermined value, an icon IC5 corresponding to “upload” may be displayed, as shown in FIG. 12(A), instead of the icon IC1 corresponding to “resize” shown in FIG. 8(A) and FIG. 8(B). Furthermore, when the image file contains moving-image data, an icon IC6 corresponding to “edit moving image” may be displayed, as shown in FIG. 12(B), instead of the icon IC4 corresponding to “retouch” shown in FIG. 12(A).

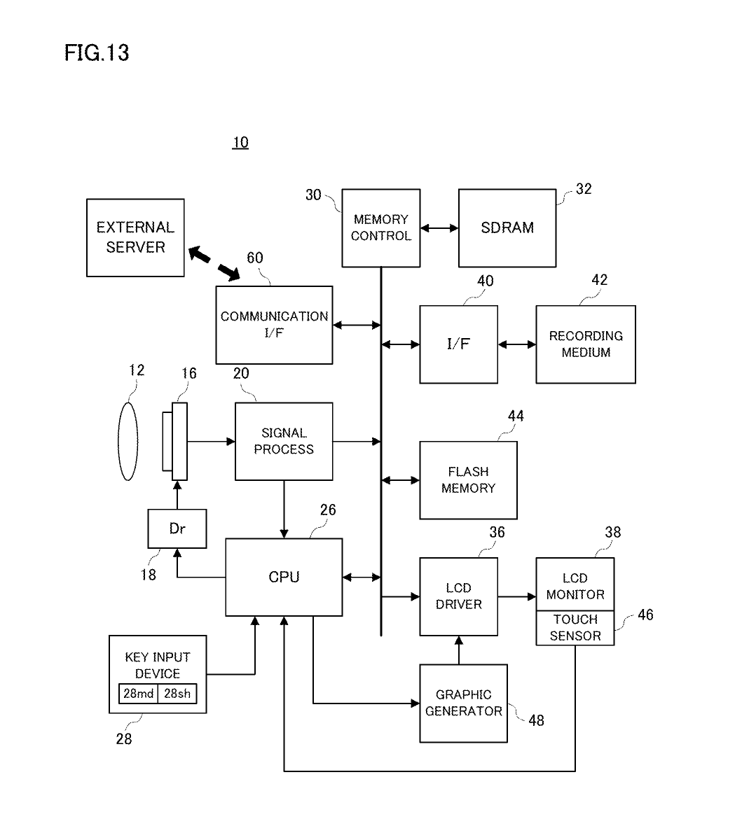

Furthermore, in this embodiment, a multi-task OS and the control program equivalent to a plurality of tasks executed by this are stored in the flash memory 44 in advance. However, a communication I/F 60 for a connection to an external server may be provided in the digital camera 10 as shown in FIG. 13, one portion of the control program may be prepared in the flash memory 44 as an internal control program from the beginning, and another portion of the control program may be acquired as an external control program from an external server. In this case, the above-described operations are implemented by the cooperation of the internal control program and the external control program.

Furthermore, in this embodiment, the processes executed by the CPU 26 are divided into a plurality of tasks including the reproducing task shown in FIG. 9 and FIG. 10. However, these tasks may be further divided into a plurality of smaller tasks, and furthermore, one portion of the plurality of divided smaller tasks may be integrated with other tasks. Furthermore, when a transfer task is divided into a plurality of smaller tasks, the whole or one portion of the transfer tasks may be acquired from an external server.

Furthermore, this embodiment is described by using a digital still camera. However, the present invention can be applied to a digital video camera, a mobile phone terminal, a smart phone, and the like.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image reproducing apparatus, comprising:
a first displayer which displays a photographed image having a size equivalent to a size of a monitor screen, on the monitor screen;
a first changer which changes a position of the photographed image displayed by said first displayer when a position changing operation is sensed so as to ensure a vacant region in a peripheral portion of the monitor screen; and
a second displayer which displays attribute information indicating an attribute of the photographed image displayed by the first displayer, in the vacant region ensured by said first changer.

2. An image reproducing apparatus according to claim 1, further comprising an updater which updates a display target of said first displayer when an image updating operation is sensed.

3. An image reproducing apparatus according to claim 1, further comprising an identifier which identifies a manner of a touch operation on the monitor screen, wherein said first changer senses a touch operation involving a slide not exceeding a reference amount, as the position changing operation, and said updater senses a touch operation involving a slide exceeding the reference amount, as the image updating operation.

4. An image reproducing apparatus according to claim 1, wherein said first displayer includes an executor which executes a displaying process on any one of a plurality of photographed images, and further comprises a third displayer which displays a photographed image different from the photographed image associated with the process of said executor, from among the plurality of photographed images, in the vacant region ensured by said first changer.

5. An image reproducing apparatus according to claim 4, wherein the photographed image associated with the process of said updater is equivalent to the photographed image associated with the process of said third displayer, said image reproducing apparatus further comprising:
a second changer which progressively changes, when the position changing operation is ended, a display position of the photographed image to a position displayed by said first displayer; and
a third changer which progressively changes, when the image updating operation is ended, a display position of the photographed image associated with the process of said third displayer to a position associated with the process of said updater.

6. An image reproducing apparatus, comprising:
a fourth displayer which displays the photographed image on the monitor screen;
a reducer which reduces a size of the photographed image displayed by said fourth displayer, in response to a pinch-in operation on the monitor screen;
a fifth displayer which displays one or at least two icons in a vacant region formed, by the process by said reducer, in a peripheral portion of the monitor screen;
a receiver which receives a selection operation for selecting any one of the one or at least two icons displayed by said fifth displayer; and
a processor which executes a process corresponding to an icon selected by the selection operation, on the photographed image displayed by said fourth displayer.

7. An image reproducing apparatus according to claim 6, further comprising an identifier which identifies a manner of a touch operation on the monitor screen, wherein said receiver receives a touch operation involving a slide exceeding a reference amount, as the selection operation.

8. An image reproducing program which is recorded on a non-temporary recording medium in order to control an image reproducing apparatus, wherein the program causes a processor of the image reproducing apparatus to execute:
a first display step of displaying a photographed image having a size equivalent to a size of a monitor screen, on the monitor screen;
a first change step of changing a position of the photographed image displayed by said first display step, when a position change operation is sensed, so as to ensure a vacant region in a peripheral portion of the monitor screen; and
a second display step of displaying attribute information indicating an attribute of the photographed image displayed by said first display step, in the vacant region ensured by said first change step.

9. An image reproducing method executed by an image reproducing apparatus, comprising:
a first display step of displaying a photographed image having a size equivalent to a size of a monitor screen, on the monitor screen;
a first change step of changing a position of the photographed image displayed by said first display step, when a position change operation is sensed, so as to ensure a vacant region in a peripheral portion of the monitor screen; and
a second display step of displaying attribute information indicating an attribute of the photographed image displayed by said first display step, in the vacant region ensured by said first change step.
